(19) United States
(12) Patent Application Publication
(10) Pub. No.: US 2014/0140462 A1
(43) Pub. Date: May 22, 2014

(54) Process

(71) Applicant: Luis A.M.M. Barbosa, Alkmaar (NL)

(72) Inventor: Luis A.M.M. Barbosa, Alkmaar (NL)

(21) Appl. No.: 14/131,921

(22) PCT Filed: Jul. 13, 2012
(86) PCT No.: PCT/US2012/046574

§ 371 Date: Jan. 10, 2014

(30) Foreign Application Priority Data
Jul. 13, 2011 (GB) 1112051.6

(51) Int. Cl. G21G 1/04

(52) U.S. Cl. CPC G21G 1/04
USPC 376/156

(57) ABSTRACT

A process for producing Tc-99m comprises the steps of contacting a solution of purified Mo-99 with an adsorbent material comprising i) a tin oxide, or ii) a zirconium oxide and a titanium oxide, such that the Tc-99m resulting from the decay of Mo-99 may thereafter be eluted.

The present invention relates to a process. In particular, though not exclusively, it relates to a process for producing Tc-99m. It also relates to an apparatus for carrying out the process.

Technetium-99m is the most widely used radiometal for medical diagnostic and therapeutic applications. Tc-99m is prepared by decay of Mo-99 in Tc-99m generators. Such a generator typically comprises an aqueous solution of Mo-99 loaded onto an adsorbent (usually alumina). Following decay of the Mo-99 to Tc-99m, which has a lower affinity for the alumina, the Tc-99m may be eluted, typically using a saline solution.

In order to obtain Mo-99 of high specific activity, it is commonly prepared by the neutron-induced fission of a U-235 target. U-235 is typically present in a target form of U-metal foil, or tubular constructs of U and A1. Alternatively, the U may be in solution in an acidic medium (such as in uranium solution targets, or as in the uranium solution used as fuel in a homogeneous reactor). The fission reaction leads to a proportion of the U-235 being converted to Mo-99, but also leads to a number of impurities, which include Cs, Sr, Ru, Zr, Te, Ba, Al and alkaline and alkaline earth metals, in the reactor output. The fission products are then subjected to purification processes to extract Mo-99 from the various impurities.

In addition to using U-235 as a source of Mo-99, alternative ways of producing Mo-99 involve the use of other stable molybdenum isotopes, such as Mo-98 or Mo-100. For example, Mo-99 can also be produced from neutron irradiation of Mo-98 (n-Mo-99) or proton irradiation of Mo-100 (p-Mo-99). However, the drawback of these alternative methods is the very low specific activity of the resulting n- or p-Mo-99. To prepare conventional Mo-99/Tc-99m generators using n- or p-Mo-99 it would be necessary to use more of the current sorbent (alumina type A or R) in order to achieve similar total Mo-99 activities; therefore the result will be larger columns and generator devices.

Although, for the reasons given above, it is generally preferred to use fission Mo-99 (i.e. from U-235) for production of Tc-99m generators, the supply of fission Mo-99 can suffer from temporary significant disruptions. Accordingly, there is a need for a suitable approach to the production of Tc-99m generators which does not rely on fission Mo-99.

Sorbents based on zirconium, titanium or oxides thereof are known to have high affinity for Mo-99. For instance, RU228516 discloses the use of Termoxid-5 sorbents (ZrO₂ and TiO₂) for Mo-99 extraction from nitric acid solutions of irradiated uranium target; WO 01/53205 discloses the use of a composition of hydrated TiO₂ combined with ZrOH for Mo-99 extraction from uranyl sulfate solutions. However, these documents concern the purification of Mo-99 from a solution resulting directly from the uranium irradiation. Such a solution comprises various fission products as well as uranium.

In addition, U.S. Pat. No. 4,782,231 discloses a Mo-99/Tc-99m generator composed of a material selected from the group consisting of aluminium, zirconium, quartz, carbon and oxides thereof; JP10030027 discloses a molybdenum adsorbing agent comprising repeating units of zirconium compounds for use in a Mo-99/Tc-99m generator; Mushtaq et al. (1991) discloses the use of hydrated titanium dioxide as an adsorbent for a Mo-99/Tc-99m generator; Chakravarty et al. (2009) discloses the use of zirconia as a sorbent for a Mo-99/Tc-99m generator; US 2009/0277828 discloses that Zr-containing adsorbents have a high affinity for Mo-99 and can be used in Tc-99m generators. These documents do not, however, address the combination of high affinity and physical stability characteristics which could render a generator more useful with n- or p-Mo-99.

According to the first aspect of the present invention, there is provided a process for producing Tc-99m, the process comprising the steps of contacting a solution of purified Mo-99 with an adsorbent material comprising i) a tin oxide, or ii) a zirconium oxide and a titanium oxide, such that the Tc-99m resulting from the decay of Mo-99 may thereafter be eluted.

The adsorbent material used in the process of the present invention provides several advantages. For instance, the adsorbent material has a high affinity for Mo-99, thereby resulting in the ability to produce a compact Mo-99/Tc-99m generator which can use Mo-99 with a high specific activity (e.g. fission Mo-99) as well as Mo-99 with a low specific activity (e.g. n- or p-Mo-99) as the starting material. Therefore, the process of the present invention provides flexibility to the user in the choice of the starting Mo-99 material.

In addition, the adsorbent material has a high physical stability, which allows it to withstand harsh treatment conditions. For example, when Mo-99 is produced from

Mo-98 neutron irradiation or Mo-100 proton irradiation, the solution of purified Mo-99 contains a certain amount of parent Mo-98 and Mo-100. Once molybdenum is adsorbed onto the adsorbent material used in the present invention, Mo-98 or Mo-100 will remain attached to the adsorbent material as they do not decay to Tc-99m. Due to its high physical stability, the adsorbent material can undergo treatment, following use of the generator, to extract the residual Mo-98 and Mo-100 (e.g., by the use of a strong basic solution, such as aqueous NaOH, or concentrated NH₄OH solution). The extracted Mo-98 or Mo-100 can be reused for further Mo-99 production. Similarly, the regenerated adsorbent material can be recycled for use in the production of further Mo-99/Tc-99m generators. In contrast, the conventional alumina sorbents used for Tc-99m generators cannot be recycled because the alumina is eroded by any treatment to extract molybdenum.

The term “a solution of purified Mo-99”, as used herein, refers to a Mo-99-containing solution resulting from Mo-98 neutron irradiation or Mo-I 00 proton irradiation, or a Mo-99 containing solution originating from U-235 fission and which has undergone at least one purification step to remove non-molybdenum metal impurities from the Mo-99-containing solution. Such purification steps are well known to those skilled in the art. For example, when Mo-99 is produced from uranium irradiation, the purification step may involve at least one, and preferably a series of, chromatographic separations on various adsorbents to harvest the Mo-99 from a solution obtained by alkaline dissolution of an irradiated U target (Samek and Ache, 1987).

In some embodiments, the tin oxide may be tin (II) oxide (i.e. SnO) or tin (IV) oxide (i.e. SnO₂). Preferably, the tin oxide is SnO₂.

In some embodiments, the titanium oxide may be titanium (II) oxide (i.e. TiO), titanium (III) oxide (i.e. Ti₂O₃), titanium (IV) oxide (i.e. TiO₂), Ti₂O₃ or Ti₃O. Preferably, the titanium oxide is TiO₂.

In a preferred embodiment, the adsorbent material may comprise a tin oxide and a titanium oxide, such as Termoxid-52, or a zirconium oxide and a titanium oxide, such as Termoxid-5M (Termoxid Scientific & Production Co., Zorechnyi, Russia). The titanium oxide enhances the physical stability of the sorbent, and may be present as a support for the tin or zirconium oxide.

In addition to the nature of the adsorbent material used, the speed and efficiency of adsorption also, in part, depend on the particle size of the adsorbent material. In general, small particle size gives increased surface area and hence better adsorption. However, if the particle size is too small, the flow of the solution of Mo-99 can be undesirably affected. Therefore, in some embodiments, the particle size of the adsorbent material used ranges from 0.001 mm to 3 mm, preferably 0.01 mm to 2 mm, more preferably 0.1 mm to 1.5 mm. Alternative particle size ranges may be from 0.001 mm to 0.2 mm or 0.1 mm. In certain embodiments, the particle size is from 0.2 mm to 1 mm. In particular embodiments, the particle size of the adsorbent material ranges from 0.4 mm to 1 mm, for example 0.45 mm to 0.65 mm. The particle size to be considered is preferably the mean diameter (such as the weight average or number average mean diameter) of the adsorbent particles in a given sample. In certain embodiments, substantially all (such as 70% or more, 80% or more, 90% or more) the adsorbent particles have a size falling within the ranges listed above, particularly 0.2 mm to 1 mm (preferably 0.4 mm to 1 mm, such as 0.45 mm to 0.65 mm)

Unexpectedly, it has been found that when the particle size range is as described above, especially in the range of 0.4 mm to 1 mm, a compact, multipurpose generator can be obtained which does not suffer from bleeding or breakthrough of Mo-99 by means of channelling (i.e. the passage through the generator of solution phase material which has not been had adsorbed), as would normally be expected at such high particle sizes.

In some embodiments in which Mo-99 with high specific activity is used, the solution of purified Mo-99 may be contacted with the adsorbent material in the presence of a molybdenum carrier. For such a purpose, ‘cold’ molybdenum may be added as molybdate or poly-molybdate (molybdenum in acid solution). The presence of the molybdenum carrier allows Mo-99 to be better dispersed through the column (preventing undesired Mo-99/Tc-99m self-reduction and Mo-99 breakthrough).

In certain embodiments, the process may further comprise the steps of allowing sufficient time for the Mo-99 to decay and eluting Tc-99m. The time sufficient for the Mo-99 to decay to Tc-99m is well known to those skilled in the art. It may be between 1 and 30 hours, preferably between 5 and 20 hours. Typically, Mo-99 is left to decay for a period of 1 to 3 half-lives of the daughter nuclide (t_{1/2} for Tc-99m=6 hours). Therefore, a Tc-99m generator is typically used for between 6 and 18 hours. The methods for eluting Tc-99m are also well known to those skilled in the art. It includes, but is not limited to, the use of a saline solution, such as sterile normal saline.

In particular embodiments, the process further comprises the step of recycling the adsorbent material by removing residual Mo. As mentioned above, this recycling step, e.g., using a strong basic solution to remove the Mo, allows the adsorbent to be re-used. Thus, in some embodiments, the process also includes a further step of contacting a second solution of purified Mo-99 with the recycled adsorbent. According to a second aspect of the present invention, there is provided an apparatus for carrying out the process of the first aspect of the present invention, the apparatus comprising a column or vessel containing an adsorbent material comprising i) a tin oxide, or ii) a zirconium oxide and a titanium oxide, and being provided with a shielding component.

The apparatus according to the present invention provides a number of advantages. For instance, the same column (of the same size and having the same amount of adsorbent) can be used for multiple types of Mo-99 solution (i.e. both low specific activity and high specific activity). Accordingly, the apparatus only needs a single column to be able to accommodate both types of Mo-99 solution. In contrast, conventional generators, in order to be usable with low specific activity Mo-99, must comprise a further, separate column for concentrating Tc-99m in the generator eluate, in addition to the column for use with high specific activity Mo-99. This requirement inevitably makes conventional generators larger than the apparatus of the present invention. In addition, the apparatus of the present invention allows a fast elution procedure. in contrast, conventional generators, when loaded with low specific activity Mo-99, generally use a longer elution time.

The adsorbent material according to the second aspect of the present invention is as defined according to the first aspect.

The shielding component is suitable for providing the user of the apparatus (or Tc-99m generator) with shielding from gamma or other radiation emitted by radioactive isotopes present in the apparatus. The degree of shielding should be sufficient to conform with recognised standards in the radiopharmaceutical industry. For example, so as to result in a transport index (TI) of less than 10 (10 mrem h⁻¹ (0.1 mSv h⁻¹)). More preferably, the degree of shielding used is such that the TI is 5 or less (5 mrem h⁻¹ (0.1 mSv h⁻¹)). The specific shielding used in the apparatus of the present invention depends on the amount of Mo-99 activity loaded onto the column. In some embodiments, the shielding component is made of lead. The shielding component may take the form of a casing which surrounds the column or vessel containing the adsorbent.

In some embodiments in which the apparatus is used to generate Tc-99m from Mo-99 having a high specific activity, the apparatus further comprises a vessel containing a solution of a molybdenum carrier, and arranged in upstream fluid communication with the column or vessel containing the adsorbent material.

According to a third aspect of the present invention, there is provided a process for recycling a Tc-99m generator, the generator comprising an adsorbent material comprising i) a tin oxide, or ii) a zirconium oxide and a titanium oxide, the process comprising the step of removing residual molybdenum from the adsorbent material.

As mentioned above, due to its high physical stability, the adsorbent material can undergo treatment, following use of the generator, to extract the residual Mo-98 and Mo-100 such that both the extracted molybdenum and the recycled adsorbent material can be re-used in the production of a further Tc-99m generator, thereby making the production of Tc-99m more cost effective. The process for recycling may also be used for generators which have been loaded with Mo-99 derived from U-235 fission.

The adsorbent material according to the third aspect of the present invention is as defined according to the first aspect.

In some embodiments, the step of removing residual molybdenum from the adsorbent material comprises contacting the adsorbent with a strong basic solution, such as an aqueous NaOH solution or concentrated NH₄OH solution.

In certain embodiments, the process further comprises the step of contacting a solution of purified Mo-99 with the recycled adsorbent material.

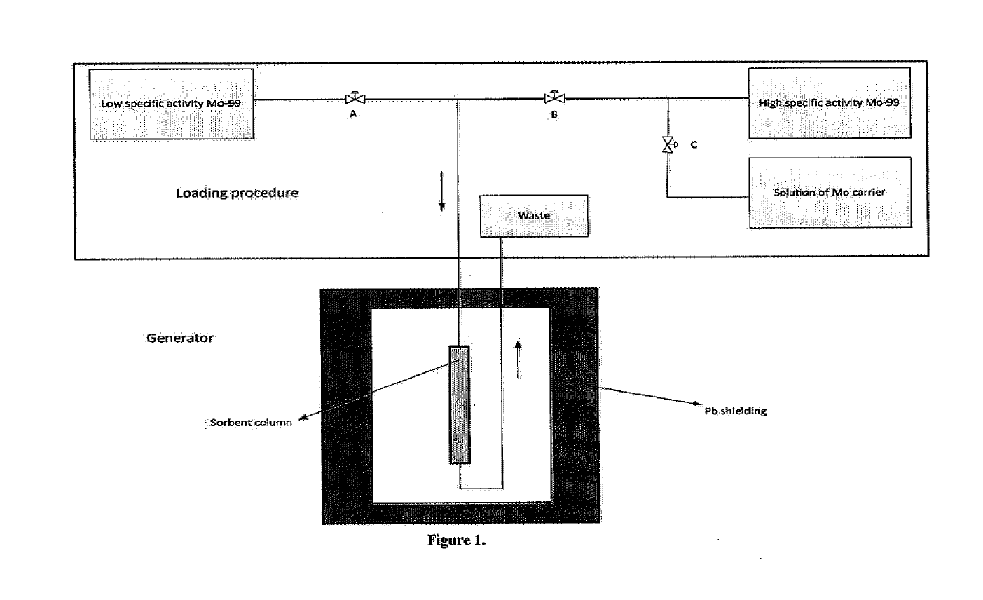

The invention will now be described in more detail by way of example only with reference to FIG. 1, which is a schematic diagram of an exemplary process of the invention.

Known Mo-99/Tc-99m generators are optimised to use ‘fission Mo-99’, which means

Mo-99 produced by U-235 fission. The fission Mo-99 has a very high specific activity, which enables the production of compact Mo-99/Tc-99m generators that contain relatively high activities of Mo-99. Often, large producers of fission Mo-99 must halt production in order to conduct scheduled or unscheduled maintenance on the reactors or production equipment, causing the availability of fission Mo-99 to be drastically reduced. Alternative ways to produce Mo-99 are possible which do not use U-235 as a source of Mo-99. Most of these alternative approaches use other molybdenum stable isotopes (Mo-98 or Mo-100), either by neutron irradiation of Mo-98 (n-Mo-99), or by proton irradiation of Mo-100 (p-Mo-99). The drawback of these initiatives is the very low specific activity of the n- or p-Mo-99.

To prepare conventional Mo-99/Tc-99m generators using n- or p-Mo-99 it would be necessary to use more of the current sorbent (alumina type A or R) in order to achieve similar total Mo-99 activities; therefore the result will be larger columns and generator devices. The invention mitigates this problem by changing the current sorbent to the new generation of commercially available sorbents based on SnO₂/TiO₂, ZrO₂/TiO₂ or one of these oxides (such as Termoxid-5M or Termoxid-52) (Termoxid Scientific & Production Co., Zorechnyi, Russia). The new generation sorbent can be used for both situations: fission and n-Mo-99/p-Mo-99, keeping the compactness of the generator design and making the resulting generator multi-purpose.

The Mo-99/Tc-99m generator is loaded with an acidic solution comprising Mo-99 with low or high specific activity. In case of the low specific activity, there is no need to use a molybdenum carrier because the Mo-99 will be dispersed through the column (preventing undesired Mo-99 /Tc-99m self reduction and Mo-99 breakthrough) due to the presence of molybdenum carrier from the molybdenum targets (Mo-98 or Mo-100). In case of the high specific activity Mo-99, a molybdenum carrier should ideally be added to the loading solution to create similar dispersion, as found in the case of the low specific activity Mo-99 solution. The low level of Mo-99 breakthrough of generators of the invention is attributable to the higher affinity of the sorbent for molybdenum (compared to prior art generators), which will also prevent any problems during the elution of Tc-99m. The degree of lead shielding of the generator will be calculated depending on the Mo-99 activity loaded into the column.

### REFERENCES

Chakravarty et al., Journal of Labelled Compounds and Radiopharmceuticals, 2009, 52, pS500;

Mushtaq et al., Journal of Radioanalytical and Nuclear Chemistry, 1991, 147(2), p257;

Sameh and Ache, Radiochim. Acta, 1987, 41, p65.

1. A process for producing Tc-99m, the process comprising the steps of contacting a solution of purified Mo-99 with an adsorbent material comprising i) a tin oxide, or ii) a zirconium oxide and a titanium oxide, such that the Tc-99m resulting from the decay of Mo-99 may thereafter be eluted.

2. A process according to claim 1, wherein the adsorbent material comprises a tin oxide and a titanium oxide.

3. A process according to claim 1, wherein the adsorbent material comprises a zirconium oxide and a titanium oxide is Termoxid-5M.

4. A process according to claim 2, wherein the adsorbent material comprises a tin oxide and a titanium oxide is Termoxid-52.

5. A process according to claim 1, wherein the process further comprises the steps of allowing sufficient time for the Mo-99 to decay, and eluting Tc-99m.

6. A process according to claim 5, wherein the process further comprises recycling the adsorbent material by removing residual molybdenum and optionally contacting a second solution of purified Mo-99 therewith.

7. A process according to claim 1, wherein the solution of purified Mo-99 is contacted with the adsorbent material in the presence of a molybdenum carrier.

8. A process according to claim 1, wherein the particle size of the adsorbent material ranges from 0.001 mm to 3 mm.

9. A process according to claim 8, wherein the particle size of the adsorbent material ranges from 0.2 mm to 1 mm.

10. A process according to claim 9, wherein the particle size of the adsorbent material ranges from 0.4 mm to 1 mm.

11. An apparatus for carrying out the process of claim 1, the apparatus comprising a column or vessel containing an adsorbent material comprising i) a tin oxide, or ii) a zirconium oxide and a titanium oxide, and being provided with a shielding component.

12. An apparatus according to claim 11, further comprising a vessel containing a solution of molybdenum carrier, and arranged in upstream fluid communication with the column or vessel containing the adsorbent material.

13. An apparatus according to claim 10, wherein the particle size of the adsorbent material ranges from 0.001 mm to 3 mm.

14. An apparatus according to claim 13, wherein the particle size of the adsorbent material ranges from 0.2 mm to 1 mm.

15. An apparatus according to claim 14, wherein the particle size of the adsorbent material ranges from 0.4 mm to 1 mm.

16. A process for recycling a Tc-99m generator, the generator comprising an adsorbent material comprising i) a tin oxide, or ii) a zirconium oxide and a titanium oxide, the process comprising the step of removing residual molybdenum from the adsorbent material.

17. A process according to claim 16, wherein the step of removing residual molybdenum from the adsorbent material comprises contacting the adsorbent material with a strong basic solution.

18. A process according to claim 16 further comprising the step of contacting a solution of purified Mo-99 with the recycled adsorbent material.

19. A process according to claim 16, wherein the particle size of the adsorbent material ranges from 0.001 mm to 3 mm.

20. A process according to claim 19, wherein the particle size of the adsorbent material ranges from 0.2 mm to 1 mm.

21. A process according to claim 20, wherein the particle size of the adsorbent material ranges from 0.4 mm to 1 mm.
